(19) United States
(12) Patent Application Publication
(10) Pub. No.: US 2026/0153435 A1
(43) Pub. Date: Jun. 4, 2026

(54) HIGH SENSITIVITY OPTICAL SENSOR BASED ON MULTI-PASS STRUCTURE

(71) Applicant: ELECTRONICS AND TELECOMMUNICATIONS RESEARCH INSTITUTE, Daejeon (KR)

(72) Inventors: Jin Hwa RYU, Daejeon (KR); Soo Cheol Kim, Daejeon (KR); Yu Sun Ahn, Dejeon (KR); Hoe Sung Yang, Daejeon (KR); Kang Bok Lee, Daejeon (KR); Kwang Soo Cho, Daejeon (KR); Kyu Won Han, Daejeon (KR)

(21) Appl. No.: 19/323,768

(22) Filed: Sep. 9, 2025

(30) Foreign Application Priority Data
Dec. 4, 2024 (KR) 10-2024-0178998

(51) Int. Cl. G01N 21/31

(52) U.S. Cl. CPC G01N 21/31; G01N 2201/08

(57) ABSTRACT

The present invention relates to a high sensitivity optical sensor based on a multi-pass structure, which includes an optical source which emits an optical signal, an optical device module which propagates and guides the optical signal in a predetermined direction, and an optical detector which measures the optical signal, wherein the optical device module includes a sensor part in which the optical signal comes into contact with a measurement target material and a plurality of optical devices which circularly control a propagation path of the optical signal to bring the optical signal into contact with the measurement target material multiple times in the sensor part.

### CROSS-REFERENCE TO RELATED APPLICATION

This application claims priority to and the benefit of Korean Patent Application No. 10-2024-0178998, filed on Dec. 4, 2024, the disclosure of which is incorporated herein by reference in its entirety.

### BACKGROUND

### 1. Field of the Invention

The present invention relates to a high sensitivity optical sensor based on a multi-pass structure.

### 2. Discussion of Related Art

Materials have unique properties according to structures and compositions of molecules constituting the materials and have inherent optical properties. An optical sensor may be described through a technology for measuring the presence/absence or concentration of a measurement target material (component) by bringing an optical signal with specific energy into contact with the measurement target material and measuring a changed optical signal. When the optical signal comes into contact with the measurement target material, an absorption and scattering phenomenon occurs depending on components constituting the measurement target material. Various optical sensor studies are being conducted using these properties of optical signals.

Materials are formed of compositions of molecules, and the molecules are formed of atoms bonded together. In this case, the molecules constituting the materials have intrinsic vibrational energy according to energy levels of the atoms, and the vibrational energy of the molecules shows unique intrinsic properties of components. These properties may be defined as molecular fingerprints. The molecular fingerprints are the unique intrinsic properties of the components and are bases for precisely identifying the components of measurement target materials. By using these properties, a gas sensor in a non-dispersive infrared (NDIR) method based on a principle that a gas absorbs an optical signal with a specific wavelength range is being studied, and in addition, Raman spectroscopy or the like which identifies components by measuring a scattered optical signal when the optical signal comes into contact with a measurement target material is typically studied for an optical sensor using the molecular fingerprint.

The related art of the present invention is disclosed in Korean Patent Publication No. 10-1705602 (Feb. 6, 2017).

### SUMMARY OF THE INVENTION

A technical objective of the present invention is directed to providing a high sensitivity optical sensor based on a multi-pass structure in which a light propagation path structure is simply implemented to improve sensor sensitivity by amplifying a weak optical sensor signal.

According to an aspect of the present invention, there is provided a high sensitivity optical sensor based on a multi-pass structure, which includes an optical source which emits an optical signal, an optical device module which propagates and guides the optical signal in a predetermined direction, and an optical detector which measures the optical signal, wherein the optical device module includes a sensor part in which the optical signal comes into contact with a measurement target material and a plurality of optical devices which circularly control a propagation path of the optical signal to bring the optical signal into contact with the measurement target material multiple times in the sensor part.

In the present invention, the plurality of optical devices may include a first optical device which allows the optical signal emitted from the optical source to be incident on the optical device module, a second optical device which is connected to an end of one of first optical wires extending from both sides of the first optical device such that the optical signal circulates through a second optical wire connected to one side of the second optical device in a circulation structure and comes into contact with the measurement target material multiple times in the sensor part, and a third optical device of which one side is connected to an end of the other of the first optical wires and allows the optical signal to circulate through a third optical wire connected to the other side of the third optical device in a circulation structure and to come into contact with the measurement target material multiple times in the sensor part.

In the present invention, the sensor part may be disposed on the first optical wire between the first optical device and the second optical device, and the optical signal may circulate through the second optical device and the third optical device and repeatedly pass through the sensor part N (N is a natural number greater than or equal to 2) times to be amplified and improve optical sensor sensitivity for the measurement target material.

In the present invention, some optical signals which circulate along the third optical wire may reach the optical detector, and the optical detector may measure a spectrum of the measurement target material using the some circulated optical signals.

In the present invention, the plurality of optical devices may include a first optical device which allows the optical signal emitted from the optical source to be incident on the optical device module and a second optical device of which one side is connected to an end of the other of first optical wires extending from both sides of the first optical device such that the optical signal circulates through a second optical wire connected to the other side of the second optical device in a circulation structure and comes into contact with the measurement target material multiple times in the sensor part.

In the present invention, the sensor part may be disposed at an end of one of the first optical wires, and the optical signal may circulate through the second optical device and repeatedly pass through the sensor part N (N is a natural number greater than or equal to 2) times to be amplified and improve optical sensor sensitivity for the measurement target material.

In the present invention, some optical signals which circulate along the second optical wire may reach the optical detector, and the optical detector may measure a spectrum of the measurement target material using the some circulated optical signals.

In the present invention, the plurality of optical devices may constitute an internal circulation circuit of the optical device module with a first optical device and a second optical device disposed on an optical wire in a circular form to be spaced apart from each other.

In the present invention, the first optical device may allow the optical signal emitted from the optical source to be incident on the internal circulation circuit of the optical device module.

In the present invention, the sensor part may be disposed on the optical wire between the first optical device and the second optical device, and the optical signal may circulate through the internal circulation circuit of the optical device module and come into contact with the measurement target material multiple times in the sensor part.

In the present invention, some optical signals which circulate along the optical wire may reach the optical detector through the second optical device, and the optical detector may measure a spectrum of the measurement target material using the some circulated optical signals.

In the present invention, the sensor part may include a core which functions as a propagation line of the optical signal and a clad which is formed outside the core and includes a core exposure region through which a portion of the core is exposed.

In the present invention, the sensor part may further include a metallic nanostructure which is formed in the core exposure region and increases amplification of the optical signal which comes into contact with the measurement target material.

In the present invention, the sensor part may include a core which functions as a propagation line of the optical signal, a clad formed outside the core, a space region which constitutes a discontinuous structure by which an optical wire with the core and the clad is divided and in which the measurement target material is located, and a light collection lens formed at an end of each optical wire in the space region.

In the present invention, the sensor part may include a core which functions as a propagation line of the optical signal, a clad formed outside the core, and a metallic nanostructure formed at a lower end of an optical wire with the core and the clad.

In the present invention, the sensor part may include a core which functions as a propagation line of the optical signal, a clad formed outside the core, a light collection lens formed at a lower and of an optical wire with the core and the clad, and a sensor cap formed at a lower end of the optical wire with the light collection lens.

In the present invention, the sensor part may further include a metallic nanostructure which is formed in the sensor cap and in which a hot spot is formed at a focal length of the light collection lens.

In the present invention, the sensor cap may include at least one hole to allow the measurement target material to enter or exit therethrough.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram for describing a high sensitivity optical sensor based on a multi-pass structure according to one embodiment of the present invention;

FIG. 2 is a block diagram for describing a high sensitivity optical sensor based on a multi-pass structure according to another embodiment of the present invention;

FIG. 3 is a block diagram for describing a high sensitivity optical sensor based on a multi-pass structure according to still another embodiment of the present invention;

FIGS. 4 and 5 are views for describing one example of a structure of a sensor part illustrated in FIGS. 1 to 3;

FIG. 6 is a view for describing another example of the structure of the sensor part illustrated in FIGS. 1 to 3; and

FIGS. 7 and 8 are views for describing still another example of the structure of the sensor part illustrated in FIGS. 1 to 3.

### DETAILED DESCRIPTION OF EXEMPLARY EMBODIMENTS

A sensor technology for qualitative and quantitative analysis of a material is increasingly replacing existing technologies due to advantages in precision, reliability, and a long lifespan of the optical sensor technology. However, in the case of the optical sensor, there is a limitation that a weak optical signal is measured in some measurement target materials. Specifically, in the case of a Raman spectroscopy, there is a limitation that most of an optical signal emitted to a measurement target material is elastically scattered (Rayleigh scattering), and Raman scattering light, which is inelastic scattering light through which components of a material may be identified, generates only an extremely weak signal at a level of about 10⁻⁶ which is 0.0001% of the scattered light.

In order to overcome this limitation, a study for amplifying a weak signal by implementing an additional technology of fabricating a metallic nanostructure such as surface enhanced Raman spectroscopy (SERS) is being conducted. However, a complex mirror-based optical system is still required, and there are limitations that an additional process is required, and additional related costs are incurred. In addition, in the case of a non-dispersive infrared (NDIR) gas sensor, a wavelength of a light source for identifying components is mostly in a mid-infrared band, and the light source in the corresponding band has a limitation in usability from a cost perspective. A light source with a wavelength band below a near-infrared band has superior usability from technical stability and cost perspectives but has a sensitivity limitation due to low optical responsiveness.

Accordingly, there is a need to develop an optical sensor technology capable of amplifying a weak optical signal with a simple structure. Hereinafter, an optical sensor technology of amplifying a weak optical signal with a simple structure will be described.

A high sensitivity optical sensor based on a multi-pass (multi-contact) structure of the present invention includes an optical source which emits an optical signal, an optical device (optical wire or optical fiber) module which propagates/guides the optical signal in a predetermined direction, and an optical detector (spectrometer) which measures the optical signal.

In this case, the optical device module may include functional optical devices (optical couplers, splitters, combiners, circulators, etc.), which may split an optical signal, combine the split optical signals, and control a propagation path, and a sensor part in which the optical signal comes into contact with a measurement target material. The optical device module is formed in a structure that allows optical signals emitted from the optical source to circulate in an optical device circuit module in a predetermined direction and only some circulated signals to reach the optical detector.

When the optical signal comes into contact with the measurement target material in the sensor part, properties such as absorption and scattering occur, and an optical sensor signal generated in this case has energy according to components of the measurement target material. When the optical signal which has reacted with the measurement target material circulates again and secondarily comes into contact with the sensor part, since the components of the measurement target material are the same, the same energy is generated, and thus the optical signal is amplified. Accordingly, when the optical signal circulates therein and repeatedly comes into contact with the sensor part N times, the optical sensor sensitivity is improved due to reinforcement interference.

Hereinafter, embodiments of the present invention will be described in detail with reference to the accompanying drawings.

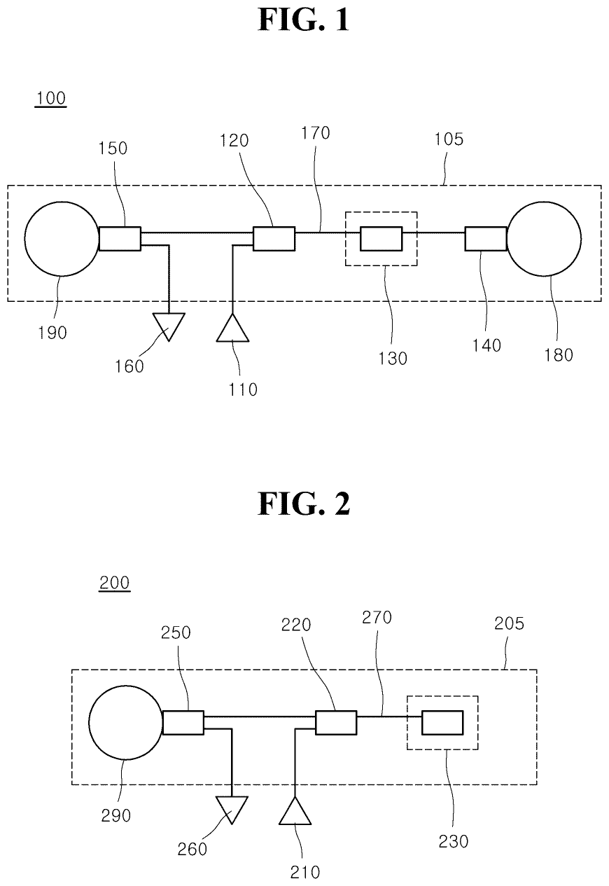

FIG. 1 is a block diagram for describing a high sensitivity optical sensor based on a multi-pass structure according to one embodiment of the present invention.

Referring to FIG. 1, a high sensitivity optical sensor 100 based on a multi-pass structure according to one embodiment of the present invention may be formed to include an optical source 110, an optical device module 105, and an optical detector 160.

The optical source 110 may emit an optical signal. The optical signal emitted from the optical source 110 may be incident on the optical device module 105.

The optical device module 105 may serve to propagate and guide the optical signal in a predetermined direction. To this end, the optical device module 105 may include a sensor part 130 in which the optical signal comes into contact with a measurement target material, a plurality of optical devices 120, 140, and 150 which circularly control a propagation path of the optical signal to bring the optical signal into contact with the measurement target material multiple times, and a plurality of optical wires 170 to 190.

In this case, the plurality of optical devices 120, 140, and 150 may include a first optical device 120 which allows the optical signal emitted from the optical source 110 to be incident on the optical device module 105, a second optical device 140 which is connected to an end of one of first optical wires 170 extending from both sides of the first optical device 120 such that the optical signal circulates through a second optical wire 180 connected to one side of the second optical device 140 in a circulation structure and comes into contact with the measurement target material multiple times in the sensor part 130, and a third optical device 150 of which one side is connected to an end of the other of the first optical wires 170 and allows the optical signal to circulate through a third optical wire 190 connected to the other side of the third optical device 150 in a circulation structure and to come into contact with the measurement target material multiple times in the sensor part 130.

The sensor part 130 may be disposed on the first optical wire 170 between the first optical device 120 and the second optical device 140 and may bring the optical signal into contact with the measurement target material. In this case, as the optical signal circulates through the second optical device 140 and the third optical device 150 to repeatedly pass through the sensor part N (N is a natural number greater than or equal to 2) times, the optical signal may be amplified. Accordingly, the optical sensor sensitivity for a measurement target material can be improved.

In this case, some optical signals which circulate along the third optical wire 190 may reach the optical detector 160. The optical detector 160 may measure a spectrum of the measurement target material using the some optical signals which have circulated along the third optical wire 190.

As described above, the optical signal emitted from the optical source 110 may be incident on the optical device module 105 through the first optical device 120 which is a functional optical device such as an optical coupler device, come into contact with the measurement target material in the sensor part 130 through the first optical wire 170, and then be guided/propagated to the second optical device 140 which is a functional optical device such as an optical coupler device.

The optical signal may be circulated along the second optical wire 180 by the second optical device 140 and then guided/propagated to the sensor part 130 again to secondarily react with the measurement target material. The guided optical signal may pass through the first optical device 120 through the first optical wire 170, then may be guided/propagated to the third optical device 150 which is a functional optical device such as an optical coupler device, may be circulated along the third optical wire 190, and may be guided/propagated to the sensor part 130.

The optical signal which comes into contact with the measurement target material for an N^{th} time in the sensor part 130 is in a state in which energy of the optical signal is accumulated up to the (N-1)^{th} time. In this case, some optical signals which circulate along the third optical wire 190 may reach a spectrometer which is one example of the optical detector 160, and the optical detector 160 may measure a spectrum of the measurement target material.

For example, the optical devices 120, 140, and 150 may be formed as devices capable of performing functions of controlling an optical signal such as an optical coupler device, an optical splitter device, an optical circulator, etc. In addition, the optical wires 170, 180, and 190 and the optical devices 120, 140, and 150 may be formed as optical waveguides such as an optical fiber, a flat optical wave circuit, etc.

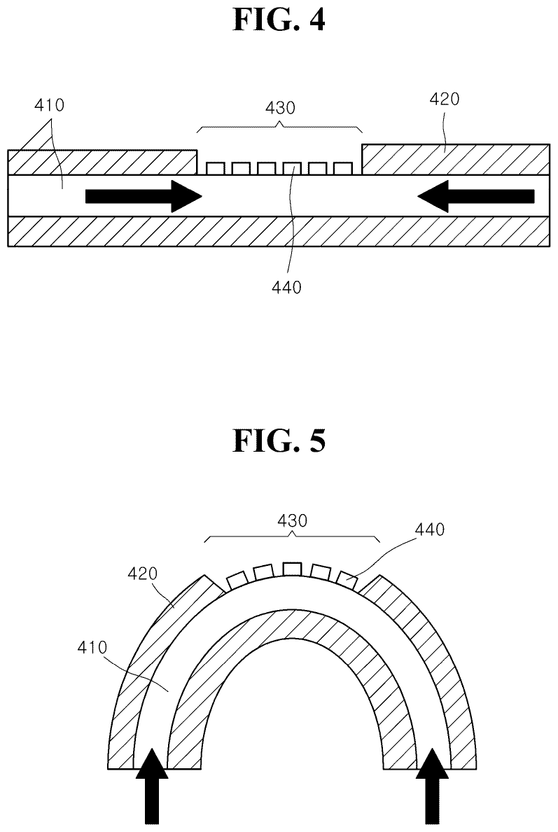

The sensor part 130 may have a structure that allows an optical signal to come into contact with a measurement target material, and more specifically, have a structure of which a core layer is partially exposed from an optical wire structure without a cladding layer or a structure having a cavity in a state in which optical axes are arranged. The sensor part 130 may be formed in a structure of a straight line, a U-bend, a probe, or the like. The structure of the sensor part 130 will be described below with reference FIGS. 4 to 8.

The optical sensor 100 according to one embodiment of the present invention described above may be formed in a structure that allows an optical signal emitted from the optical source 110 to repeatedly pass through the sensor part 130 N times while circulating in the optical device module 105, accordingly, the optical signal may be amplified, and thus the optical sensor sensitivity for a measurement target material can be improved.

FIG. 2 is a block diagram for describing a high sensitivity optical sensor based on a multi-pass structure according to another embodiment of the present invention.

Referring to FIG. 2, a high sensitivity optical sensor 200 based on a multi-pass structure according to another embodiment of the present invention may be formed to include an optical source 210, an optical device module 205, and an optical detector 260.

The optical source 210 may emit an optical signal. The optical signal emitted from the optical source 210 may be incident on the optical device module 205.

The optical device module 205 may serve to propagate and guide the optical signal in a predetermined direction. To this end, the optical device module 205 may include a sensor part 230 in which the optical signal comes into contact with a measurement target material, a plurality of optical devices 220 and 250 which circularly control a propagation path of the optical signal to bring the optical signal into contact with the measurement target material multiple times in the sensor part 230, and a plurality of optical wires 270 and 290.

In this case, the plurality of optical devices 220 and 250 may include a first optical device 220 which allows the optical signal emitted from the optical source 210 to be incident on the optical device module 205 and a second optical device 250 of which one side is connected to an end of the other of first optical wires 270 extending from both sides of the first optical device 220 such that the optical signal circulates through a second optical wire 290 connected to the other side of the second optical device 250 in a circulation structure and comes into contact with the measurement target material multiple times in the sensor part 230.

In this case, the sensor part 230 may be disposed at an end of one of the first optical wires 270. Accordingly, the optical signal may circulate through the second optical device 250 and repeatedly pass through the sensor part 230 N times, in this case, the optical signal may be amplified, and thus the optical sensor sensitivity for the measurement target material can be improved.

In this case, some optical signals which circulate the second optical wire 290 may reach the optical detector 260. The optical detector 260 may measure a spectrum of the measurement target material using the some circulated optical signals.

According to the optical sensor 200 according to another embodiment of the present invention described above, an optical signal emitted from the optical source 210 primarily comes into contact with a measurement target material in a probe which is one example of the sensor part 230, and then is circulated in the optical device module 205 by the second optical device 250, only some optical signals are propagated to a spectrometer which is one example of the optical detector 260, and most of the signal is propagated to the probe which is the sensor part 230 again and performs second and N^{th} reactions with the measurement target material.

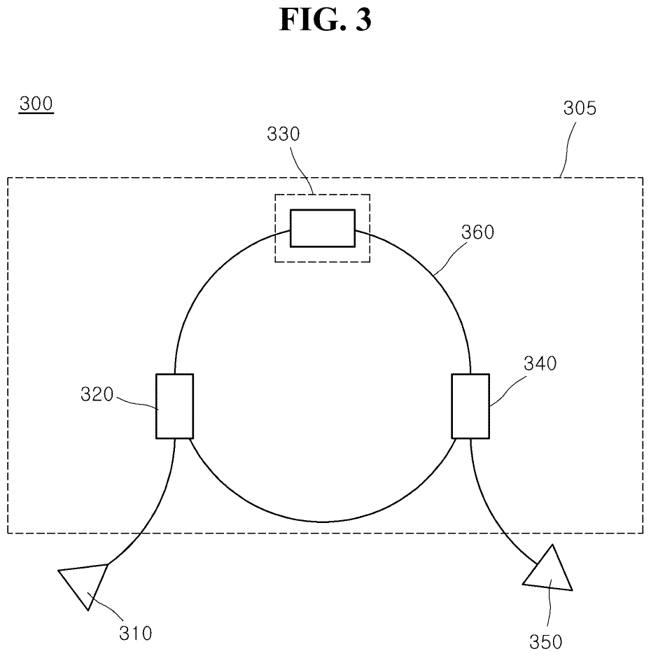

FIG. 3 is a block diagram for describing a high sensitivity optical sensor based on a multi-pass structure according to still another embodiment of the present invention.

Referring to FIG. 3, a high sensitivity optical sensor 300 based on a multi-pass structure according to still another embodiment of the present invention may be formed to include an optical source 310, an optical device module 305, and an optical detector 350.

The optical source 310 may emit an optical signal. The optical signal emitted from the optical source 310 may be incident on the optical device module 305.

The optical device module 305 may serve to propagate and guide the optical signal in a predetermined direction. To this end, the optical device module 305 may include a sensor part 330 in which the optical signal comes into contact with a measurement target material, a plurality of optical devices 320 and 340 which circularly control a propagation path of the optical signal and bring the optical signal into contact with the measurement target material multiple times in the sensor part 330, and optical wires 360 which are formed in a circle form and disposed between the sensor part 330 and the optical devices 320 and 340.

In this case, the plurality of optical devices 320 and 340 may constitute an internal circulation circuit of the optical device module 305 with a first optical device 320 and a second optical device 340 disposed on the optical wires 360 in a circular form to be spaced apart from each other.

Specifically, the first optical device 320 may allow the optical signal emitted from the optical source 310 to be incident on the internal circulation circuit of the optical device module 305. The sensor part 330 may be disposed on the optical wire 360 between the first optical device 320 and the second optical device 340. Accordingly, the optical signal may circulate through the internal circulation circuit of the optical device module 305 and come into contact with the measurement target material multiple times in the sensor part 330.

Some optical signals which circulate the optical wire 360 may reach the optical detector 350 through the second optical device 340. The optical detector 350 may measure a spectrum of the measurement target material using the some circulated optical signals.

According to the optical sensor 300 according to still another embodiment of the present invention described above, an optical signal emitted from the optical source 310 is incident on the internal circulation circuit of the optical device module 305 through the first optical device 320 and then comes into contact with a measurement target material in the sensor part 330. Then, the optical signal may be propagated/guided to the second optical device 340, only some optical signals may be propagated to a spectrometer which is the optical detector 350, and most of the remaining signals may be propagated to the sensor part 330 again. Accordingly, second and N^{th} sensor signals may be generated.

FIGS. 4 and 5 are views for describing one example of a structure (cross-sectional structure in a propagation path direction of an optical signal) of the sensor part illustrated in FIGS. 1 to 3.

Referring to FIGS. 1 to 4, each of the sensor parts 130 and 330 may include a core 410, a clad 420, a core exposure region 430, and a metallic nanostructure 440.

The core 410 may function as a propagation line of an optical signal. The clad 420 may be formed outside the core 410.

As described above, the clad 420 may be formed at the outer side around the core 410. The clad 420 may include the core exposure region 430 through which a portion of the core 410 is exposed.

The metallic nanostructure 440 may be formed in the core exposure region 430. The metallic nanostructure 440 may serve to amplify the optical signal which comes into contact with a measurement target material. When the metallic nanostructure 440 is formed as a nano particle or nano wire, the amplification of the signal is increased.

Meanwhile, as illustrated in FIG. 5, each of the sensor parts 130 and 330 may be formed in a rounded shape having a predetermined curvature. Each of the sensor parts 130 and 330 formed in the rounded shape may include a core 410, a clad 420, a core exposure region 430, and a metallic nanostructure 440 like each of the sensor parts 130 and 330 of the FIG. 4, and the components may have the same or similar functions.

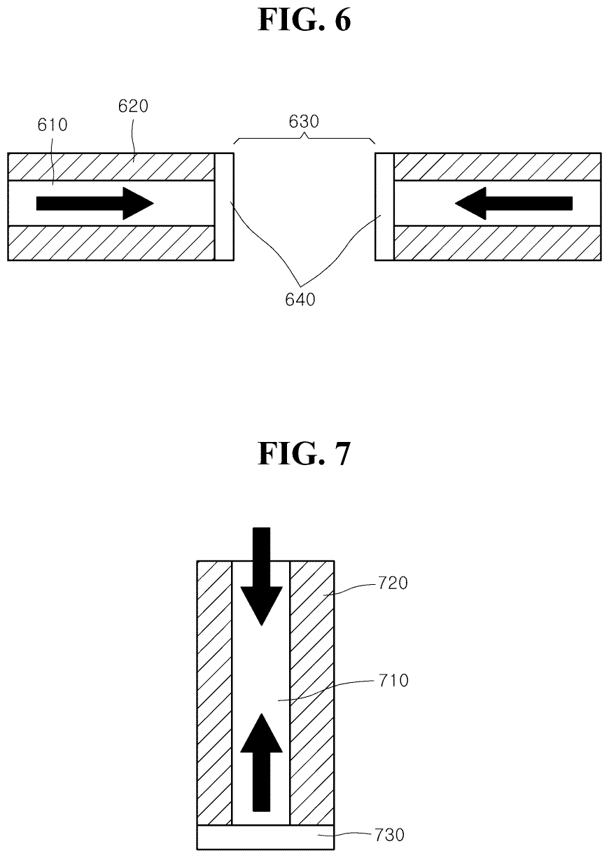

FIG. 6 is a view for describing another example of the structure of the sensor part illustrated in FIGS. 1 to 3.

Referring to FIG. 6, each of the sensor parts 130 and 330 may be formed to include a core 610, a clad 620, a space region 630, and light collection lenses 640.

The core 610 may function as a propagation line of an optical signal. The clad 620 may be formed outside the core 610.

As described above, the clad 620 may be formed at the outer side around the core 610.

The space region 630 is a region constituting a discontinuous structure by which an optical wire with the core 610 and the clad 620 is divided, and a measurement target material may be located in the discontinuous structure.

The light collection lenses 640 may be formed at ends of the optical wire in the space region 630 and serve to collect light.

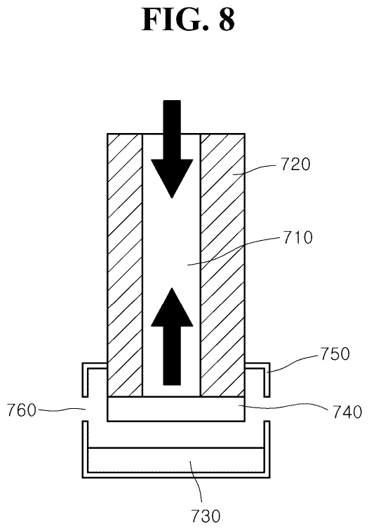

FIGS. 7 and 8 are views for describing still another example of the structure of the sensor part illustrated in FIG. 2.

Referring to FIG. 7, the sensor part 230 may include a core 710, a clad 720, and a metallic nanostructure 730.

The core 710 may function as a propagation line of an optical signal. Since the present example of the sensor part 230 has a vertical structure, the core 710 may vertically transmit the optical signal.

The clad 720 may be formed outside the core 710.

The metallic nanostructure 730 may be formed at a low end of an optical wire with the core 710 and the clad 720.

Meanwhile, as illustrated in FIG. 8, the sensor part 230 may further include a light collection lens 740 and a sensor cap 750.

The light collection lens 740 may be formed at a lower end of an optical wire with a core 710 and a clad 720.

The sensor cap 750 may be formed at a lower end of an optical wire with the light collection lens 740. A metallic nanostructure 730 may be disposed in the sensor cap 750. The metallic nanostructure 730 may be disposed in the sensor cap 750 to allow a hot spot to be formed at a focal length of the light collection lens 740.

The sensor cap 750 may include at least one hole 760 to allow a measurement target material to enter or exit therethrough.

According to the present invention, there is an effect of allowing a measurement target material to be qualitatively and quantitatively analyzed based on a simple optical circuit structure.

According to the present invention, since a circular optical circuit structure that allows an optical signal to repeatedly come into contact with a measurement target material N times is implemented, there is an effect of amplifying a weak optical sensor signal.

According to the present invention, since an optical signal emitted from an optical source repeatedly comes into contact with a measurement target material N times, a signal with the same properties is induced and generated, and thus there is an effect of improving the sensitivity of an optical sensor.

According to the present invention, since materials have intrinsic properties according to components thereof, there is an effect of a technology of quantitatively analyzing similar materials and field verification, diagnosis, and analysis in bio, medical, food, chemical, and safety fields.

What is claimed is:

1. A high sensitivity optical sensor based on a multi-pass structure, comprising:
an optical source which emits an optical signal;
an optical device module which propagates and guides the optical signal in a predetermined direction; and
an optical detector which measures the optical signal,
wherein the optical device module includes a sensor part in which the optical signal comes into contact with a measurement target material, and a plurality of optical devices which circularly control a propagation path of the optical signal to bring the optical signal into contact with the measurement target material multiple times in the sensor part.

2. The high sensitivity optical sensor of claim 1, wherein the plurality of optical devices include:
a first optical device which allows the optical signal emitted from the optical source to be incident on the optical device module;
a second optical device which is connected to an end of one of first optical wires extending from both sides of the first optical device such that the optical signal circulates through a second optical wire connected to one side of the second optical device in a circulation structure and comes into contact with the measurement target material multiple times in the sensor part; and
a third optical device of which one side is connected to an end of the other of the first optical wires and allows the optical signal to circulate through a third optical wire connected to the other side of the third optical device in a circulation structure and to come into contact with the measurement target material multiple times in the sensor part.

3. The high sensitivity optical sensor of claim 2, wherein:
the sensor part is disposed on the first optical wire between the first optical device and the second optical device; and
the optical signal circulates through the second optical device and the third optical device and repeatedly passes through the sensor part N (N is a natural number greater than or equal to 2) times to be amplified and improve optical sensor sensitivity for the measurement target material.

4. The high sensitivity optical sensor of claim 2, wherein:
some optical signals which circulate along the third optical wire reach the optical detector; and
the optical detector measures a spectrum of the measurement target material using the some circulated optical signals.

5. The high sensitivity optical sensor of claim 1, wherein the plurality of optical devices include:
a first optical device which allows the optical signal emitted from the optical source to be incident on the optical device module; and
a second optical device of which one side is connected to an end of the other of first optical wires extending from both sides of the first optical device such that the optical signal circulates through a second optical wire connected to the other side of the second optical device in a circulation structure and comes into contact with the measurement target material multiple times in the sensor part.

6. The high sensitivity optical sensor of claim 5, wherein:
the sensor part is disposed at an end of one of the first optical wires; and
the optical signal circulates through the second optical device and repeatedly passes through the sensor part N (N is a natural number greater than or equal to 2) times to be amplified and improve optical sensor sensitivity for the measurement target material.

7. The high sensitivity optical sensor of claim 5, wherein:
some optical signals which circulate along the second optical wire reach the optical detector; and
the optical detector measures a spectrum of the measurement target material using the some circulated optical signals.

8. The high sensitivity optical sensor of claim 1, wherein the plurality of optical devices constitute an internal circulation circuit of the optical device module with a first optical device and a second optical device disposed on an optical wire in a circular from to be spaced apart from each other.

9. The high sensitivity optical sensor of claim 8, wherein the first optical device allows the optical signal emitted from the optical source to be incident on the internal circulation circuit of the optical device module.

10. The high sensitivity optical sensor of claim 9, wherein:
the sensor part is disposed on the optical wire between the first optical device and the second optical device; and
the optical signal circulates through the internal circulation circuit of the optical device module and comes into contact with the measurement target material multiple times in the sensor part.

11. The high sensitivity optical sensor of claim 8, wherein:
some optical signals which circulate along the optical wire reach the optical detector through the second optical device; and
the optical detector measures a spectrum of the measurement target material using the some circulated optical signals.

12. The high sensitivity optical sensor of claim 1, wherein the sensor part includes:
a core which functions as a propagation line of the optical signal; and
a clad which is formed outside the core and includes a core exposure region through which a portion of the core is exposed.

13. The high sensitivity optical sensor of claim 12, wherein the sensor part further includes a metallic nanostructure which is formed in the core exposure region and increases amplification of the optical signal which comes into contact with the measurement target material.

14. The high sensitivity optical sensor of claim 1, wherein the sensor part includes:
a core which functions as a propagation line of the optical signal;
a clad formed outside the core;
a space region which constitutes a discontinuous structure by which an optical wire with the core and the clad is divided and in which the measurement target material is located; and
a light collection lens formed at an end of each optical wire in the space region.

15. The high sensitivity optical sensor of claim 1, wherein the sensor part includes:
a core which functions as a propagation line of the optical signal;
a clad formed outside the core; and
a metallic nanostructure formed at a lower end of an optical wire with the core and the clad.

16. The high sensitivity optical sensor of claim 1, wherein the sensor part includes:
a core which functions as a propagation line of the optical signal;
a clad formed outside the core;
a light collection lens formed at a lower and of an optical wire with the core and the clad; and
a sensor cap formed at a lower end of the optical wire with the light collection lens.

17. The high sensitivity optical sensor of claim 16, wherein the sensor part further includes a metallic nanostructure which is formed in the sensor cap and in which a hot spot is formed at a focal length of the light collection lens.

18. The high sensitivity optical sensor of claim 16, wherein the sensor cap includes at least one hole to allow the measurement target material to enter or exit therethrough.
